(19) United States
(12) Patent Application Publication
(10) Pub. No.: US 2026/0258874 A1
(43) Pub. Date: Sep. 3, 2026

(54) MULTI-VALVE

(71) Applicants: HYUNDAI MOTOR COMPANY, Seoul (KR); KIA CORPORATION, Seoul (KR); Hanon Systems, Daejeon (KR)

(72) Inventors: Jeong Wan Han, Daejeon (KR); Gwang Ok Ko, Daejeon (KR); Hyun Woong Shin, Daejeon (KR); Shin-Won Yun, Daejeon (KR); Min Ho Jang, Daejeon (KR); Seong Woo Jeong, Daejeon (KR); Jungbum Choi, Daejeon (KR); Dong Seok Oh, Hwaseong-si (KR); Jung Ha Park, Hwaseong-si (KR); Yong Woong Cha, Hwaseong-si (KR); Seong Bin Jeong, Hwaseong-si (KR); Eon Soo Yun, Hwaseong-si (KR)

(73) Assignees: HYUNDAI MOTOR COMPANY, Seoul (KR); KIA CORPORATION, Seoul (KR); Hanon Systems, Daejeon (KR)

(21) Appl. No.: 19/408,016

(22) Filed: Dec. 3, 2025

(30) Foreign Application Priority Data
Feb. 28, 2025 (KR) 10-2025-0026895

(51) Int. Cl. F16K 11/076

(52) U.S. Cl. CPC F16K 11/076

(57) ABSTRACT

A multi-valve includes a valve housing having a plurality of first ports along a first column and a plurality of second ports along a second column and includes a valve rotor disposed inside the valve housing and configured to be rotatable according to an air-conditioning mode. The valve rotor has a plurality of communication flow paths each configured to connect one port of the plurality of ports to one or more other ports thereof. Based on first ports of the first column being a first port group and second ports of the second column being a second port group, the first ports in the first port group and the second ports in the second port group are disposed alternately with a predetermined interval between the first and second port groups.

### CROSS-REFERENCE TO RELATED APPLICATION

This application claims, under 35 U.S.C. § 119(a), the benefit of and priority to Korean Patent Application No. 10-2025-0026895, filed on Feb. 28, 2025, the entire contents of which are incorporated herein by reference.

### BACKGROUND

### (a) Technical Field

The present disclosure relates to a multi-valve capable of controlling fluid in a plurality of directions and providing various operation modes.

### (b) Background Art

Recently, environmental regulations have been strictly strengthened. Also, there has been increasing demand for sustainable vehicles such as electric vehicles (EVs) and hybrid electric vehicles (HEVs). Accordingly, the automobile industry is rapidly transitioning from internal combustion engine (ICE) vehicles to eco-friendly vehicles. Eco-friendly vehicles, such as electric vehicles (EVs), plug-in hybrid electric vehicles (PHEVs), and fuel cell electric vehicles (FCEVs), have been provided as key alternatives to reduce emission of carbon-containing gases into the atmosphere. Thus, research and development has been actively conducted on techniques related to eco-friendly vehicles. Such transition from ICE vehicles to eco-friendly vehicles affects a driving system of a vehicle and various additional systems thereof. Therefore, new designs and technical requirements need to be taken into consideration.

In the case of eco-friendly vehicles using electric motors and batteries as power sources, it is necessary to provide a cooling system configured to perform thermal management on power electronics (PE) devices, high-voltage batteries, motors, and the like. Particularly, since batteries are sensitive to temperature changes, performance and lifespan of the batteries are guaranteed only when the batteries are maintained within a certain temperature range. Accordingly, an efficient thermal management system needs to be provided to ensure optimal performance and longevity of batteries. Due to increasing system requirements for eco-friendly vehicles, a structural configuration of an air-conditioning system in such vehicles has become complicated.

Due to increasing complexity of the air-conditioning system and the thermal management system, a valve system configured to control the air-conditioning system and the thermal management system has also become more sophisticated and multifunctional. In a conventional air-conditioning system having a simple configuration, the flow of air and coolant is controlled using a few valves. Meanwhile, in the case of eco-friendly vehicles, multiple cooling loops are employed to cool batteries and power electronics and to maintain optimal operating temperatures, resulting in increased valve system complexity. In addition, since fluid needs to be distributed through various paths to maximally increase efficiency of cooling and heating, it is difficult to effectively control distribution of the fluid using a conventional opening/closing valve having a simple configuration.

The above information disclosed in this Background section is only to enhance understanding of the background of the disclosure. Therefore, the Background section may contain information that does not form the prior art that is already known to a person of ordinary skill in the art.

### SUMMARY OF THE DISCLOSURE

The present disclosure has been made in an effort to solve the above-described problems associated with the prior art. It is an aspect of the present disclosure to provide a multi-valve capable of efficiently managing a cooling system and an air-conditioning system, each having a complicated structural configuration.

It is another aspect of the present disclosure to provide a multi-valve capable of optimizing the flow of fluid by combining various flow paths in one valve.

It is still another aspect of the present disclosure to provide a multi-valve capable of improving a degree of freedom of connection between ports without an increase in flow path resistance within the valve.

The aspects of the present disclosure are not limited to the above-mentioned aspects. Other technical aspects not mentioned herein should be more clearly understood by those of ordinary skill in the art to which the present disclosure pertains from the detailed description of the embodiments.

In one aspect, the present disclosure provides a multi-valve including a valve housing having a plurality of ports disposed or positioned, i.e., formed along a first column and a second column of the valve housing, and including a valve rotor disposed inside the valve housing and configured to be rotatable according to an air-conditioning mode. The valve rotor has a plurality of communication flow paths each disposed or positioned, i.e., formed to connect one port of the plurality of ports to another port thereof. Based on first ports of the plurality of ports in the first column being a first port group and based on second ports of the plurality of ports in the second column being a second port group, the first ports in the first port group and the second ports in the second port group are disposed alternately at a predetermined interval between the first and second port groups.

In an embodiment, at least one of the plurality of communication flow paths may include a diagonal flow path configured to connect any one port in the first port group to an adjacent port in the second port group.

In another embodiment, the expression 0.7≤W2/W1<1.0 may be satisfied, where W1 is a width of a widest portion of the diagonal flow path and W2 is a width of a narrowest portion of the diagonal flow path.

In still another embodiment, the first column and the second column may be parallel to a rotation axis of the valve rotor.

In yet another embodiment, the first column and the second column may be disposed spaced apart from each other by a predetermined distance. The expression 1.0≤T/D≤2.0 may be satisfied, where T is a distance between the first column and the second column, and D is a diameter of a port.

In still yet another embodiment, each of the communication flow paths may be formed as any one path selected from among the diagonal flow path, a vertical flow path configured to connect the ports in the first port group or to connect the ports in the second port group, or a merged flow path obtained by merging the diagonal flow path with the vertical flow path.

In a further embodiment, each of the communication flow paths may connect one port of the plurality of ports to the other port thereof or may connect one port of the plurality of ports to two other ports thereof.

In another further embodiment, the valve rotor may include a closed flow path configured to block at least one port of the plurality of ports.

In still another further embodiment, respective communication flow paths may have distinct patterns, and the distinct patterns may be circumferentially formed with a predetermined angular interval between the distinct patterns.

In yet another further embodiment, the valve rotor may include a plurality of partition walls. Each of the partition walls may be formed to radially protrude to distinguish between the distinct patterns. The valve rotor may be rotated according to the air-conditioning mode so as to connect, based on each of the distinct patterns, ports of the plurality of ports to each other in a different manner.

In still yet another further embodiment, a first half of the plurality of ports may be inlet ports configured for coolant intake. A second half of the plurality of ports may be outlet ports configured for discharging the coolant. One of the inlet ports may be configured for introducing the coolant from a reservoir tank and at least one of the outlet ports may be configured to discharge the coolant via a water pump.

In another aspect, the present disclosure provides a multi-valve including a valve housing having a plurality of ports formed along a first column and a second column of the valve housing and including a valve rotor disposed inside the valve housing and configured to be rotatable according to an air-conditioning mode. The valve rotor has a plurality of communication flow paths each disposed or positioned, i.e., formed to connect one port of the plurality of ports to another port thereof. The valve rotor includes an outer cylinder and an inner cylinder spaced apart from the outer cylinder by a predetermined distance and disposed inside the outer cylinder. Each of the plurality of communication flow paths is an outer flow path formed in a surface portion of the outer cylinder or an inner flow path formed in a space between the outer cylinder and the inner cylinder.

In an embodiment, some ports of the plurality of ports may be connected to each other through the outer flow path, and other ports thereof may be connected to each other through the inner flow path.

In another embodiment, based on first ports of the first column being a first port group and based on second ports of the second column being a second port group, the first ports in the first port group and the second ports in the second port group may be disposed alternately at a predetermined interval between the first and second port groups. At least one of the plurality of communication flow paths may include a diagonal flow path configured to connect any one first port in the first port group to any one second port in the second port group.

In still another embodiment, the expression 0.7≤W2/W1<1.0 may be satisfied, where W1 is a width of a widest portion of the diagonal flow path, and W2 is a width of a narrowest portion of the diagonal flow path.

Other aspects and embodiments of the disclosure are discussed herein.

It should be understood that the terms “vehicle”, “vehicular”, and other similar terms as used herein are inclusive of motor vehicles in general. Such vehicles may encompass passenger automobiles including sport utility vehicles (SUVs), buses, trucks, various commercial vehicles, watercraft including a variety of boats and ships, aircraft, and the like. Such vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed herein.

### BRIEF DESCRIPTION OF THE DRAWINGS

The above and other features of the present disclosure are described in detail with reference to certain embodiments thereof illustrated in the accompanying drawings, which are given hereinbelow by way of illustration only, and thus are not limitative of the present disclosure, and wherein:

FIG. 1 is an example of a hydraulic circuit diagram to which a multi-valve according to an embodiment of the present disclosure is applied;

FIG. 2 is a front view of a valve housing according to an embodiment of the present disclosure;

FIG. 3A is a perspective view and FIG. 3B an exploded perspective view of a valve rotor according to an embodiment of the present disclosure;

FIG. 4 is a top view of a rotor body according to an embodiment of the present disclosure;

FIG. 5 is an enlarged view of an L2 flow path of the valve rotor in FIG. 3;

FIG. 6 is a view showing an example of a pattern in which a plurality of communication flow paths are formed in a valve rotor according to an embodiment of the present disclosure;

FIG. 7 is a hydraulic circuit diagram of the flow path pattern shown in FIG. 6;

FIG. 8 is another example of a flow path pattern according to an embodiment of the present disclosure;

FIG. 9 is a hydraulic circuit diagram showing fluid inlet and outlet directions of ports of a valve rotor according to an embodiment of the present disclosure;

FIG. 10 is a top view of a rotor body according to another embodiment of the present disclosure;

FIG. 11 is a view showing an example of a pattern in which a plurality of communication flow paths are formed in a valve rotor according to an embodiment of the present disclosure;

FIG. 12A is a view showing an inner flow path among a plurality of communication flow paths in a valve rotor and FIG. 12B is a cross section taken along line A-A′ of the valve rotor in FIG. 12A; and

FIG. 13 is a hydraulic circuit diagram of the flow path pattern shown in FIG. 11.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, the same reference numbers refer to the same or equivalent parts of the present disclosure throughout the several figures of the drawings.

### DETAILED DESCRIPTION

Hereinafter, the technical concepts of the present disclosure are described in detail with reference to the accompanying drawings. However, the detailed description discloses and describes example embodiments. The present disclosure is not limited to a specific embodiment described herein. When a component, device, apparatus, valve, body, housing, or the like of the present disclosure is described as having a purpose or performing an operation, function, or the like, the component, device, valve, body, or housing should be considered herein as being “configured to” meet that purpose or to perform that operation or function.

A multi-valve 1000 according to the present disclosure may be applied to vehicles including hybrid electric vehicles, fuel vehicles, and pure electric vehicles. The multi-valve 1000 may be employed as a device or apparatus to switch a supply path of fluid (i.e., coolant) and may be applied to heat exchange fields such as household or industrial applications. Further, the multi-valve may be used in some equipment required for cooling and heating.

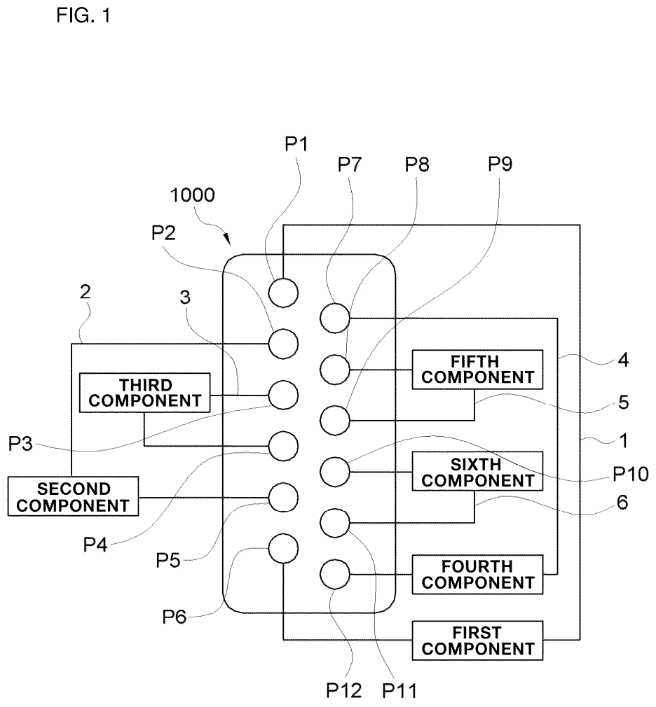

The multi-valve 1000 according to a first embodiment of the present disclosure is described below with reference to FIG. 1. FIG. 1 is an example of a hydraulic circuit diagram to which the multi-valve 1000 according to the first embodiment of the present disclosure is applied.

The multi-valve 1000 may control a flow of fluid to select a flow path. The multi-valve 1000 may be connected to a plurality of loops 1-6. Depending on mode switching of the multi-valve 1000, a connection state between a plurality of ports P1 to P12 may be changed, and the flow of fluid between the loops 1-6 may be changed. In addition, depending on mode switching of the multi-valve 1000, a specific loop may be activated or deactivated.

In FIG. 1, twelve ports are formed in the multi-valve 1000, and six loops are each connected to a pair of ports, but the present disclosure is not limited thereto. For example, the number of ports formed in the multi-valve 1000 may be any number such as 4, 6, 8, 10, and 14. In addition, the number of loops connected to the multi-valve 1000 may be appropriately designed to correspond to the number of ports.

A predetermined number of components may be disposed in each loop. The components may be or include, for example, a reservoir tank configured to supply coolant, a water pump configured to suction coolant from the multi-valve 1000 and to discharge the coolant to a corresponding loop, a heat exchanger configured to exchange heat with refrigerant, or a power electronics (PE) module and a battery that are cooled by coolant.

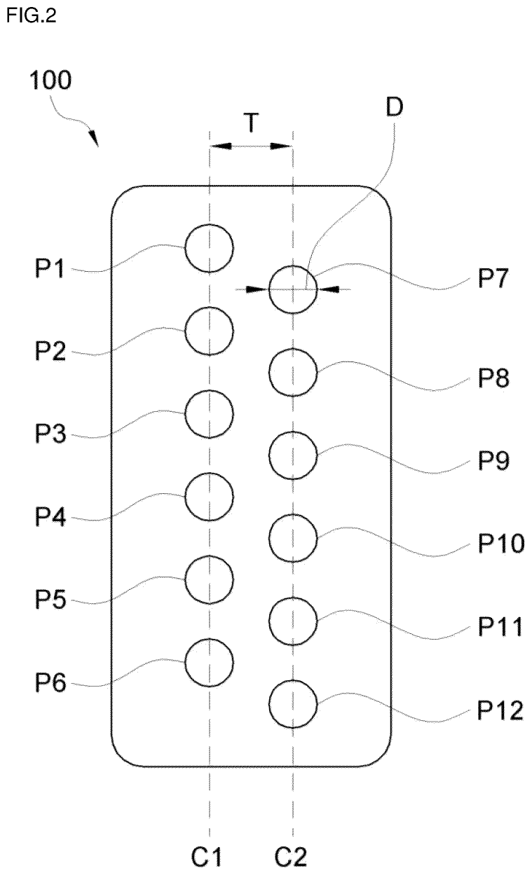

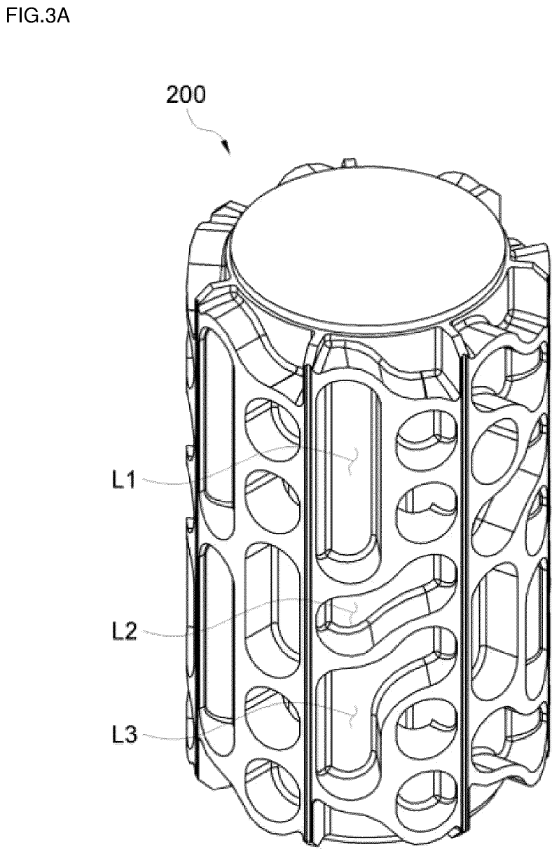

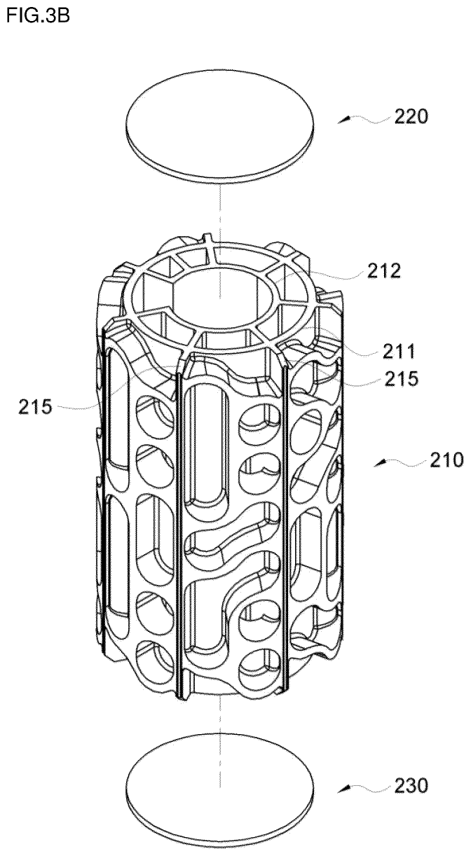

Hereinafter, the multi-valve 1000 according to the first embodiment of the present disclosure is specifically described with reference to FIGS. 2, 3A, and 3B. FIG. 2 is a front view of a valve housing 100 and FIGS. 3A and 3B are a perspective view and an exploded perspective view of a valve rotor 200.

The multi-valve 1000 according to the first embodiment of the present disclosure may include the valve housing 100 having a plurality of ports P1-P12 positioned or disposed, i.e., formed along a first column C1 and a second column C2. The multi-valve 1000 may also include a valve rotor 200 may be disposed inside the valve housing 100, may be configured to be rotatable according to an air-conditioning mode, and may be formed to have a plurality of communication flow paths, each connecting one of the plurality of ports to one or more other of the ports thereof.

The valve housing 100 may have a plurality of ports P1-formed along the first column C1 and the second column C2. Half of the plurality of ports may be formed in the first column C1, and the other half thereof may be formed in the second column C2. As shown in FIG. 2, a total of 12 ports is formed in the valve housing 100. Here, six ports P1-P6 are formed in the first column C1, and the remaining six ports P7-P12 are formed in the second column C2.

The ports P1-P6 formed in the first column C1 may be referred to as first ports in a first port group, and the ports P7-P12 formed in the second column C2 may be referred to as second ports in a second port group. In this case, the first ports P1-P6 of the first port group and the second ports P7-P12 of the second port group may be disposed alternately with a predetermined interval therebetween, i.e., between the two port groups. In other words, the corresponding first ports of the first port group and the second ports of the second port group may be disposed alternately in a zigzag configuration in the height direction without being disposed in parallel, i.e., at the same height with each other in the height direction.

In one embodiment, the first column C1 and the second column C2 may be disposed parallel to a rotation axis C0 of the valve rotor 200. The first column C1 and the second column C2 may be disposed spaced apart from each other with a predetermined distance T therebetween in the width direction. The valve rotor 200, which is described below, may be rotated according to the air-conditioning mode and may allow the ports formed in the first column C1 and/or the second column C2 to communicate with each other. Further, a connection structure between the ports may vary depending on a flow path pattern for each mode of the valve rotor 200.

In one embodiment, the distance between the first column C1 and the second column C2 is defined as T, and a diameter of the ports is defined as D. In this example, T/D may be 1.0 or more and 3.0 or less. Specifically, the expression 1.0≤T/D≤3.0 may be satisfied in one example. In another example, the expression 1.0≤T/D≤2.0 may be satisfied. In a further example, the expression 1.5≤T/D≤2.0 may be satisfied.

The first column C1 and the second column C2 may be disposed spaced apart from each other with a predetermined distance therebetween within the above-described range of T/D. In this manner, the valve size may be optimally adjusted. At the same time, since the first ports in the first column C1 and the second ports in the second column C2 are disposed alternately in a zigzag arrangement or configuration, it is possible to maximally reduce flow path resistance of a diagonal flow path in the valve rotor 200, which is described below.

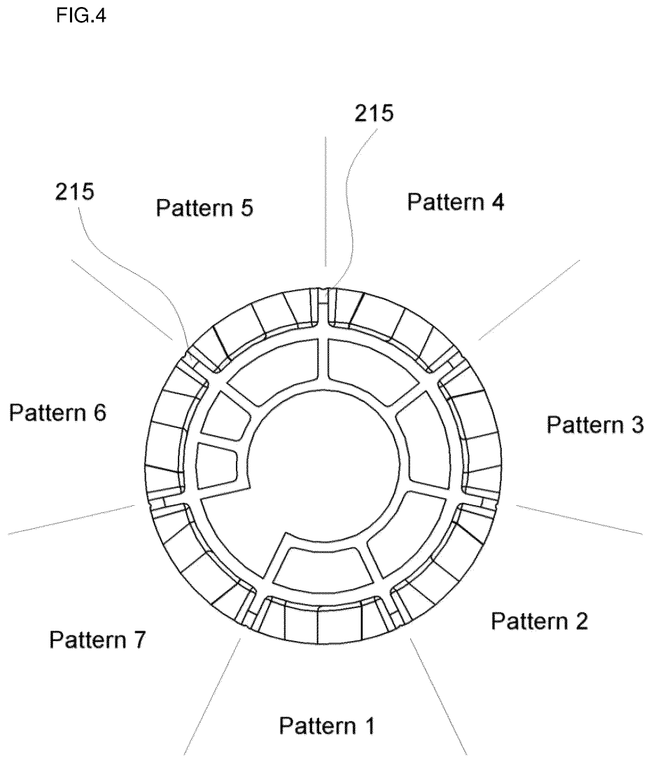

The valve rotor 200 is described below with reference to FIGS. 3A, 3B, and 4. FIG. 4 is a top view of a rotor body 210 according to the first embodiment of the present disclosure. The valve rotor 200 may have a plurality of communication flow paths including L1, L2, and L3 each formed to connect one port of the plurality of ports P1-P12 to another port thereof. Since the communication flow paths L1, L2, and L3 are disposed at positions corresponding to the plurality of ports, one port may communicate with the other one or two or more other ports.

The valve rotor 200 may include the rotor body 210, an upper cover 220, and a lower cover 230. The rotor body 210 has a plurality of communication flow paths formed or defined therein and is formed or configured to open in the vertical direction. The upper cover 220 covers an upper portion of the rotor body 210 and the lower cover 230 Covers a Lower Portion of the Rotor Body 210.

Meanwhile, as shown in FIG. 4, a plurality of communication flow paths may be formed in distinct patterns with a predetermined angular interval therebetween in the circumferential direction. A connection structure of the communication flow paths may be different for each distinct pattern. The valve rotor 200 may be rotated inside the valve housing 100 to implement different air-conditioning modes. In FIG. 4, as an example, a total of seven flow path patterns is formed in the valve rotor 200. Accordingly, a total of seven air-conditioning modes may be implemented. However, the above-mentioned structural configuration of the flow path pattern is only an example. The number of flow path patterns may be appropriately designed and changed depending on the number of desired air-conditioning modes.

In one embodiment, the valve rotor 200 may include a plurality of partition walls 215 formed to radially protrude to distinguish between the respective distinct patterns. The valve rotor 200 may be rotated inside the valve housing 100 such that the patterns of the desired air-conditioning mode are arranged to correspond to the ports in the valve housing 100. In this case, the plurality of ports may be connected to each other according to a corresponding pattern. The patterns may be blocked from each other by the partition walls 215, and the valve rotor 200 may be rotated according to the air-conditioning mode so as to connect, based on each of the patterns, the plurality of ports to each other in a different manner.

Meanwhile, at least one of the plurality of communication flow paths may include a diagonal flow path configured to connect any one port in the first port group to an adjacent port in the second port group. In FIGS. 3A and 3B, the “L2” flow path is shown as an example of a diagonal flow path. According to the present disclosure, the diagonal flow path is provided to improve connectivity between the respective ports formed in different columns. In addition, since the ports in the first column C1 and the ports in the second column C2 are disposed alternately, a flow path area of the diagonal flow path may be maintained uniformly, and a communication flow path having low flow resistance may be provided.

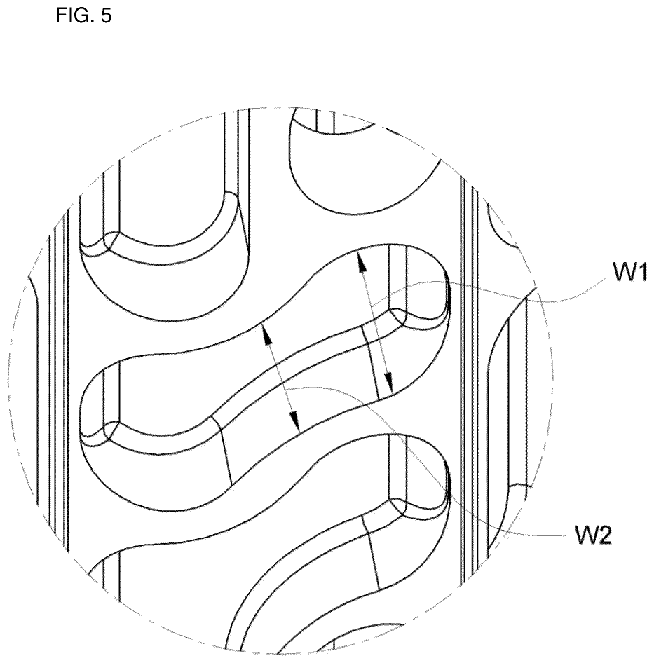

Hereinafter, a detailed description is given with reference to FIG. 5. FIG. 5 is an enlarged view of the L2 flow path shown in FIG. 3A. In one embodiment, a width of the widest portion of the diagonal flow path is defined as W1 and a width of the narrowest portion thereof is defined as W2. In this case, the expression 0.5≤W2/W1≤1.0 may be satisfied in one example. In another example, the expression 0.7≤W2/W1<1.0 may be satisfied. In another example, the expression 0.9≤W2/W1<1.0 may be satisfied.

Since the diagonal flow path is designed as described above, the flow path area may be uniformly formed, and a degree of freedom of connection between the ports may be improved.

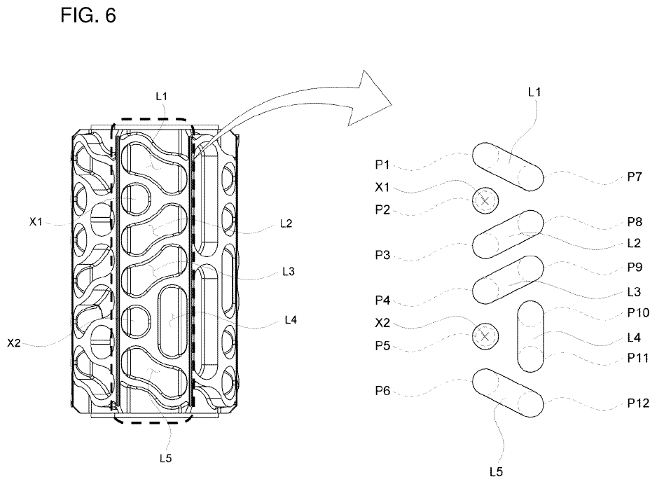

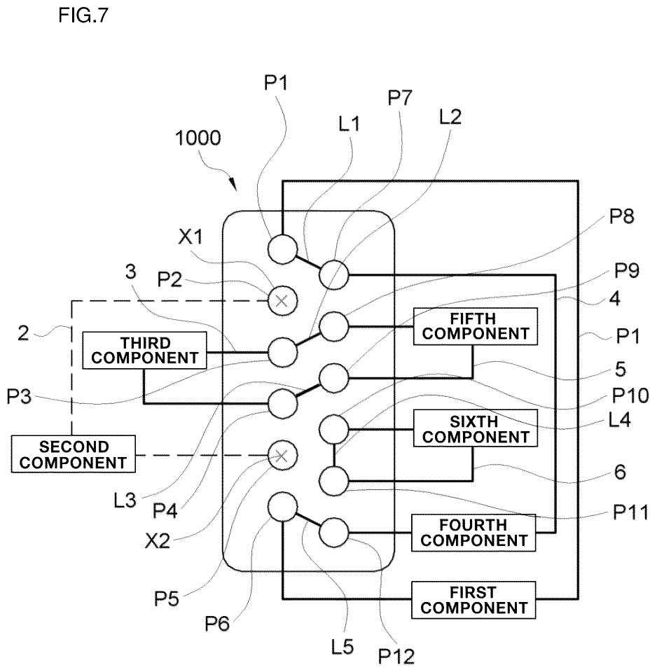

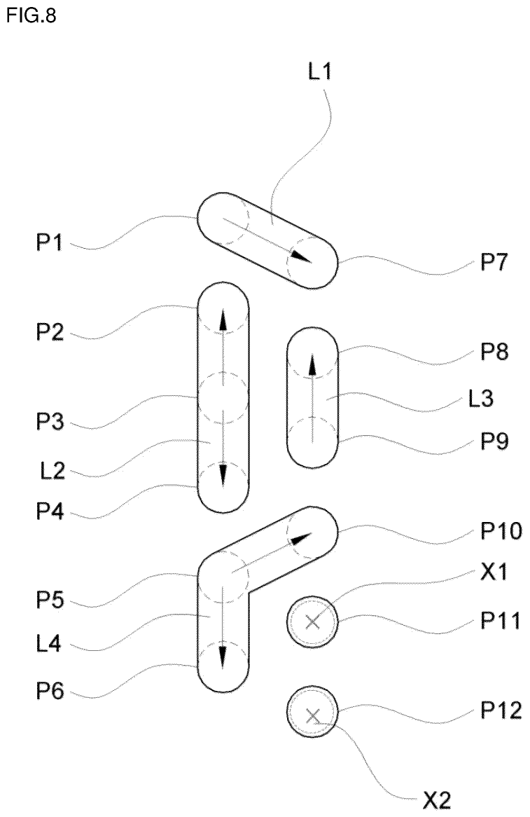

Hereinafter, the flow path pattern of the valve rotor 200 is described in detail with reference to FIGS. 6-8. FIG. 6 is a view showing an example of a pattern in which a plurality of communication flow paths are formed in the valve rotor 200. FIG. 7 is a hydraulic circuit diagram of the pattern shown in FIG. 6. FIG. 8 is a flow path pattern of another embodiment.

According to one embodiment, each of the communication flow paths may be formed as any one path selected from among a diagonal flow path, a vertical flow path connecting first ports in the first port group or connecting second ports in the second port group, and a merged flow path in which a diagonal flow path and a vertical flow path are merged.

FIG. 6 is a view showing an example of a configuration in which the communication flow paths L1, L2, L3, and L5 are formed as diagonal flow paths, and the communication flow path L4 is formed as a vertical flow path. FIG. 8 is a view showing an example of a configuration in which the communication flow path L1 is formed as a diagonal flow path, the communication flow paths L2 and L3 are formed as vertical flow paths, and the communication flow path L4 is formed as a merged flow path in which a diagonal flow path and a vertical flow path are merged.

According to the present disclosure, ports in the same port group may be connected to each other through a vertical flow path, and ports respectively formed in different port groups may be connected to each other through a diagonal flow path and/or a merged flow path. In the case of a communication flow path connecting ports respectively formed in different port groups, since a flow path area is maintained uniformly, the ports may be freely connected to each other without an increase in flow path resistance.

Meanwhile, each communication flow path may connect one port of the plurality o ports to another port thereof or may connect one port of the plurality of ports to two other ports thereof.

Referring to FIG. 8, the communication flow path L2 is formed as a vertical flow path to connect ports disposed in the same port group and is configured to connect three ports to each other simultaneously. In this case, fluid introduced into one port P3 may be distributed to the other two ports P2 and P4 and may be discharged individually. In addition, the communication flow path L4 is formed as a merged flow path such that ports in the same port group and ports in different port groups are connected to each other at the same time. Here, fluid introduced into one port P5 may be distributed to the port P6 in the same port group and the port P9 in a different port group and may be discharged individually. As a result, it is possible to improve a degree of freedom of port connection and to provide various flow path modes.

Referring back to FIGS. 6 and 7, according to one embodiment, the valve rotor 200 may include closed flow paths X1 and X2 configured to block at least one port among the plurality of ports. The closed flow paths X1 and X2 correspond to flow paths each configured to block the flow of fluid without connecting one port to the other port. A loop connected to ports respectively disposed in the closed flow paths X1 and X2 may be deactivated, and loops connected to ports respectively disposed in the communication flow paths L1-L5 may be activated.

FIGS. 6 and 7 are views each showing an example in which the ports P2 and P5 are respectively disposed in the closed flow paths X1 and X2. As shown in FIG. 7, a loop 2 connected to the ports P2 and P5 respectively disposed in the closed flow paths X1 and X2 may be deactivated, so that fluid may not flow through the loop 2. Conversely, loops 1, 3, 4, and 6 connected to the communication flow paths L1-L5 are activated, so that fluid may flow through the loops 1, 3, 4, and 6.

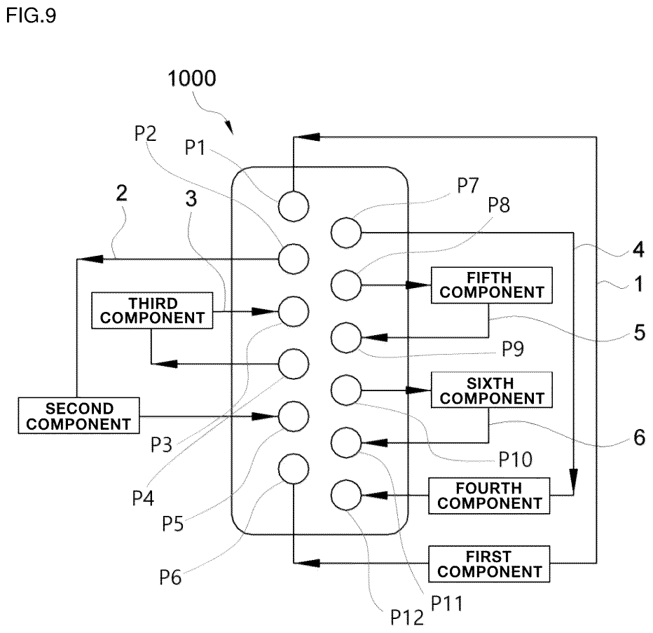

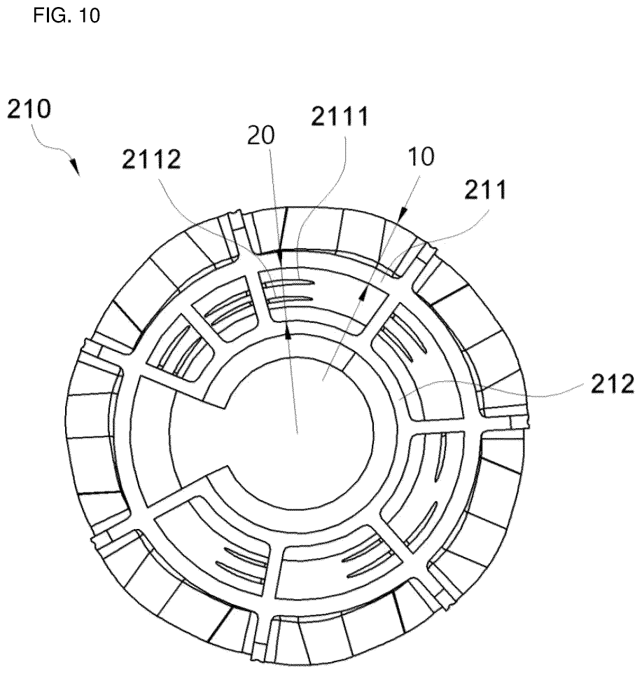

Hereinafter, a plurality of ports P1-P12 are described with reference to FIG. 9. FIG. 9 is a hydraulic circuit diagram showing the fluid inlet and outlet directions of the ports. Half of the plurality of ports may be inlet ports into which coolant is introduced, i.e., the ports intake coolant. The other half of the ports may be outlet ports from which coolant is discharged. Here, coolant from a reservoir tank may be introduced into one of the inlet ports and coolant may be discharged from at least one of the outlet ports by a water pump.

For example, a second component disposed at the front end of the port P5 may include a reservoir tank, and coolant discharged from the reservoir tank may be introduced into the multi-valve 1000 through the port P5. Alternatively, a first component and a sixth component respectively disposed in the rear ends of the ports P6 and P10 may include a water pump. Coolant may be discharged through the ports P6 and P10 and may flow toward a path to which the water pump applies pressure.

Hereinafter, the multi-valve 1000 according to a second embodiment of the present disclosure is described with reference to FIGS. 10-13. The above-described configuration of the first embodiment may be applied to the second embodiment as well. Differences in a configuration different from that of the first embodiment are mainly described below.

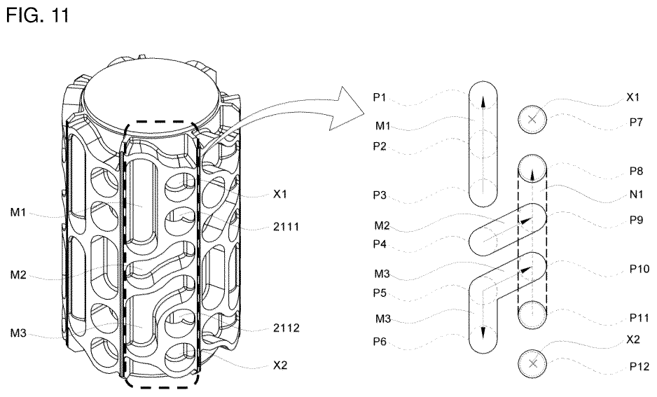

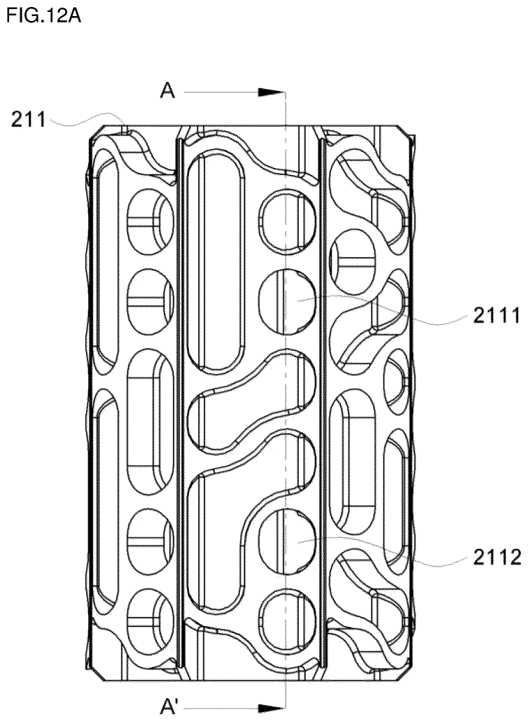

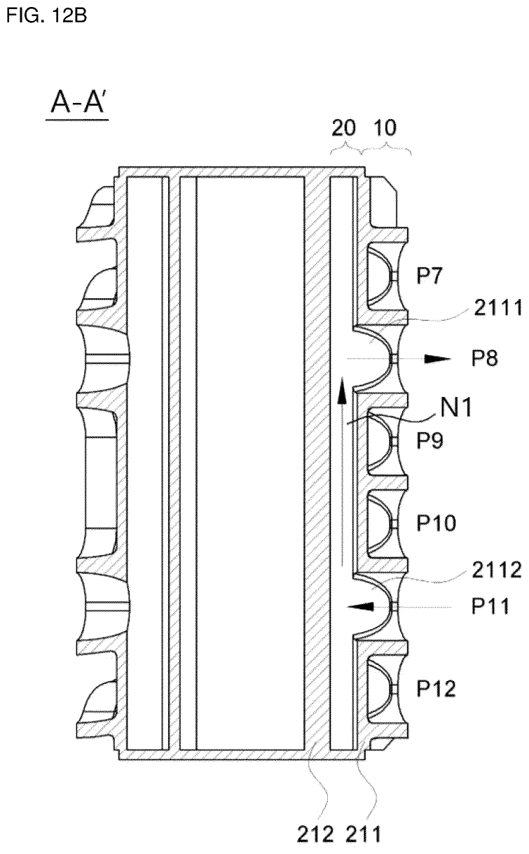

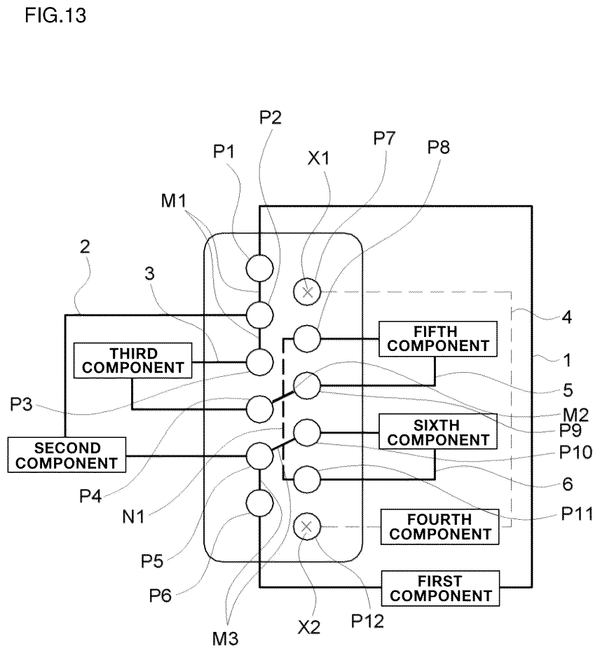

FIG. 10 is a top view of the rotor body 210 according to the second embodiment. FIG. 11 is a view showing an example of a pattern in which a plurality of communication flow paths are formed in the valve rotor. FIGS. 12A and 12B are views showing an inner flow path among the plurality of communication flow paths. FIG. 13 is a hydraulic circuit diagram of the pattern shown in FIG. 11.

According to the second embodiment of the present disclosure, the multi-valve 1000 may include the valve housing 100 having a plurality of ports formed in the first column and the second column. The multi-valve 1000 may also include a valve rotor 200 disposed inside the valve housing 100, configured to be rotatable according to an air-conditioning mode, and formed to have a plurality of communication flow paths each connecting one of the plurality of ports to one or more other of the ports thereof. The valve rotor 200 may include an outer cylinder 211 and an inner cylinder 212 spaced apart from the outer cylinder 211 by a predetermined interval and disposed inside the outer cylinder 211. Here, a plurality of communication flow paths may include outer flow paths M1, M2, and M3 formed in a surface portion 10 of the outer cylinder 211 or an inner flow path N1 formed in a space 20 between the outer cylinder 211 and the inner cylinder 212.

Here, one embodiment shows an example in which some of the plurality of ports are connected to each other through the outer flow paths M1, M2, and M3, and the remaining ports are connected to each other through the inner flow path N1. In FIG. 11, some ports P1, P2, and P3 are connected to each other through the outer flow path M1, some ports P4 and P9 are connected to each other through the outer flow path M2, some ports P5, P6, and P10 are connected to each other through the outer flow path M3, and some of the remaining ports P11 and P8 are connected to each other through the inner flow path N1.

The inner flow path N1 is not formed through a space in the surface portion 10 of the outer cylinder 211 but is formed through the space 20 between the outer cylinder 211 and the inner cylinder 212. As shown in FIG. 12, the inner flow path N1 may bypass the outer flow paths M2 and M3 formed in the surface portion 10 and the ports P9 and P10 connected to the outer flow paths and may allow the ports P8 and P11 spaced apart from each other to communicate with each other. Accordingly, the inner flow path N1 may connect one inlet port to one outlet port without disturbing the outer flow paths M1, M2, and M3 formed in the surface portion 10 and may connect ports not adjacent to each other. As a result, it is possible to improve a degree of freedom of connection between ports.

Specifically, holes 2111 and 2112 may be formed in the outer cylinder 211 and may penetrate the outer cylinder 211 to communicate with the inner flow path N1. Ports corresponding to the holes 2111 and 2112 may be connected to each other through the inner flow path N1.

Meanwhile, closed flow paths X1 and X2 configured to block at least one of the plurality of ports may be formed in the surface portion 10 of the outer cylinder 211. As shown in FIGS. 11, 12A, and 12B, the ports P7 and P12 are respectively disposed in the closed flow paths X1 and X2 to block the flow of fluid. The closed flow paths X1 and X2 block fluid from flowing therethrough by the outer cylinder 211. On the other hand, since the inner flow path N1 is connected to the holes 2111 and 2112 penetrating the outer cylinder 211, fluid may flow through the inner flow path N1, and one port may be fluidly connected to the other port by the inner flow path N1.

In one embodiment, the first ports formed in the first column may be referred to as a first port group, and the second ports formed in the second column may be referred to as a second port group. In this case, the first ports of the first port group and the second ports of the second port group may be disposed alternately with a predetermined interval therebetween, i.e., between the two port groups. Here, at least one of the plurality of communication flow paths includes a diagonal flow path configured to connect any one first port in the first port group to any one second port in the second port group.

As described above in the first embodiment, each of the outer flow paths M1, M2, and M3 may be formed as any one path selected from among a diagonal flow path configured to connect a first port in the first port group to a second port in the second port group, a vertical flow path configured to connect first ports in the first port group or second ports in the second port group, and a merged flow path in which the diagonal flow path and the vertical flow path are merged.

In one embodiment, a width of the widest portion of the diagonal flow path is defined as W1, and a width of the narrowest portion thereof is defined as W2. In this example, the expression 0.5≤W2/W1≤1.0 may be satisfied. In another example, the expression 0.7≤W2/W1<1.0 may be satisfied. In another example, the expression 0.9≤W2/W1<1.0 may be satisfied.

Meanwhile, the inner flow path N1 formed in the space 20 between the outer cylinder and the inner cylinder does not interfere with the structure of the outer flow path M1, M2, and M3 formed in the surface portion 10 of the outer cylinder. Accordingly, the inner flow path N1 may be formed in a vertical direction to connect ports in the same port group or may be formed in a diagonal direction to connect ports respectively disposed in different port groups.

Hereinafter, a description is given with reference to FIG. 13.

As shown in FIG. 13, the P8 port and the P11 port that are not adjacent to each other may be connected to each other through the inner flow path N1. The inner flow path N1 may be formed so as not to interfere with the outer flow paths M1 and M2 formed between the P8 port and the P11 port. As a result, it is possible to provide a multi-valve capable of improving a degree of freedom of connection between ports.

As is apparent from the above description, the present disclosure provides a multi-valve capable of efficiently managing a cooling system and an air-conditioning system, each having a complicated structural configuration.

Additionally, it is possible to provide a multi-valve capable of combining various flow paths in one valve, thereby having an effect of reducing the number of system components and improving space utilization.

Furthermore, it is possible to provide a multi-valve capable of improving a degree of freedom of connection between ports without an increase in flow path resistance.

The effects of the present disclosure are not limited to the above-mentioned effects. Other effects not mentioned herein should be more clearly understood by those of ordinary skill in the art to which the present disclosure pertains from the detailed description of the embodiments and the accompanying drawings.

Although the technical concepts of the present disclosure have been described in detail with reference to various embodiments thereof, the scope of the present disclosure is not limited to the above-described embodiments and the accompanying drawings. It should be appreciated by those of ordinary skill in the art to which the present disclosure pertains that various modifications and improvements may be made in the embodiments without changing the technical idea or essential features of the disclosure. Therefore, it should be understood that the above-described embodiments are illustrative in all respects and are not restrictive.

What is claimed is:

1. A multi-valve comprising:
a valve housing having first ports disposed along a first column and second ports disposed along a second column of the valve housing; and
a valve rotor disposed inside the valve housing and configured to be rotatable according to an air-conditioning mode, the valve rotor having a plurality of communication flow paths each configured to connect one port of the plurality of ports to one or more other ports thereof,
wherein, based on the first ports in the first column being a first port group and the second ports in the second column being a second port group, the first ports in the first port group and the second ports in the second port group are disposed alternately with a predetermined interval between the first and second port groups.

2. The multi-valve of claim 1, wherein at least one of the plurality of communication flow paths comprises a diagonal flow path configured to connect any one first port in the first port group to a second port in the second port group.

3. The multi-valve of claim 2, wherein an expression 0.7≤W2/W1<1.0 is satisfied, where W1 is a width of a widest portion of the diagonal flow path and W2 is a width of a narrowest portion of the diagonal flow path.

4. The multi-valve of claim 2, wherein the first column and the second column are parallel to a rotation axis of the valve rotor.

5. The multi-valve of claim 4, wherein:
the first column and the second column are disposed spaced apart from each other by a predetermined distance; and
an expression 1.0≤T/D≤2.0 is satisfied, where T is a distance between the first column and the second column and D is a port diameter.

6. The multi-valve of claim 2, wherein each of the plurality of communication flow paths is formed as any one path selected from among the diagonal flow path, a vertical flow path configured to connect first ports in the first port group or to connect second ports in the second port group, or a merged flow path obtained by merging a diagonal flow path with a vertical flow path.

7. The multi-valve of claim 6, wherein each of the communication flow paths connects one port of the plurality of ports to one other port thereof or connects one port of the plurality of ports to two other ports thereof.

8. The multi-valve of claim 1, wherein the valve rotor comprises a closed flow path configured to block at least one port of the plurality of ports.

9. The multi-valve of claim 1, wherein the plurality communication flow paths have distinct patterns, and wherein the distinct patterns are circumferentially formed with a predetermined angular interval between the patterns.

10. The multi-valve of claim 9, wherein:
the valve rotor comprises a plurality of partition walls, each of the plurality of partition walls radially protruding to distinguish between the distinct patterns; and
the valve rotor is rotated according to the air-conditioning mode so as to connect, based on each of the distinct patterns, two or more of the plurality of ports to each other in a different manner.

11. The multi-valve of claim 1, wherein:
half of the plurality of ports are inlet ports configured for intake of coolant and half of the plurality of ports are outlet ports configured to discharge the coolant;
one of the inlet ports is configured to intake coolant from a reservoir tank; and
at least one of the outlet ports is configured to discharge the coolant by a water pump.

12. A multi-valve comprising:
a valve housing having a plurality of ports including first ports disposed along a first column and second ports disposed along a second column of the valve housing; and
a valve rotor disposed inside the valve housing and configured to be rotatable according to an air-conditioning mode, the valve rotor having a plurality of communication flow paths each configured to connect one port of the plurality of ports to one or more other ports thereof,
wherein the valve rotor includes an outer cylinder and an inner cylinder spaced apart from the outer cylinder by a predetermined distance and disposed inside the outer cylinder, and
wherein each of the plurality of communication flow paths is configured as an outer flow path in a surface portion of the outer cylinder or as an inner flow path in a space between the outer cylinder and the inner cylinder.

13. The multi-valve of claim 12, wherein some of the plurality of ports are connected to each other through the outer flow path, and other of the plurality of ports are connected to each other through the inner flow path.

14. The multi-valve of claim 12, wherein:
based on the first ports of the first column being a first port group and the second ports of the second column being a second port group, the first ports in the first port group and the second ports in the second port group are disposed alternately with a predetermined interval between the first and second port groups; and
at least one of the plurality of communication flow paths includes a diagonal flow path configured to connect any one first port in the first port group to any one second port in the second port group.

15. The multi-valve of claim 14, wherein an expression 0.7≤W2/W1<1.0 is satisfied, where W1 is a width of a widest portion of the diagonal flow path and W2 is a width of a narrowest portion of the diagonal flow path.
